(19) United States
(12) Patent Application Publication
(10) Pub. No.: US 2020/0195891 A1
(43) Pub. Date: Jun. 18, 2020

(54) AISLE MARKER FOR A RETAIL STORE

(71) Applicant: SYNQ ACCESS + SECURITY TECHNOLOGY LTD., Victoria (CA)

(72) Inventors: Nolan WHEELER, Victoria (CA); Joshua RODRIGUEZ, Victoria (CA)

(21) Appl. No.: 16/712,065

(22) Filed: Dec. 12, 2019

(30) Foreign Application Priority Data
Dec. 12, 2018 (CA) 3027208

(51) Int. Cl. H04N 7/18; H04N 5/247; H04N 5/225; H04R 1/02

(52) U.S. Cl. CPC H04N 7/181; H04N 5/247; H04W 84/12; H04R 1/028; H04N 5/2253

(57) ABSTRACT

An aisle marker for a retail store has an electronic display and a security camera contained within a housing. The aisle marker is mounted via a mounting apparatus. The electronic display is angled for proper viewing by patrons below. This device negates the need for multiple wires. Optionally, there can be added a public address system and a WiFi network.

### FIELD

There is described an aisle marker used in a retail store to indicate product location.

### BACKGROUND

Currently aisle markers in retail stores are constructed of plastic, cardboard, or wood and are hung in aisles of retail stores for the purpose of indicating what products can be found in a particular aisle. There are various names for these signage items, such as aisle markers, aisle descriptors, or aisle signs. As an example, in a grocery store, the sign would show the aisle number, and approximately 8 items within the aisle. The baking aisle, would by way of example, state that: flour, sugar, spices, etc. . . . are in that aisle. Generally, these aisle markers are placed at the ‘front’ and ‘back’ of the aisle, but in some circumstances one will see aisle markers in the middle of the aisle or in other directing locations.

United States Publication 2006/0156602 (Keefe) titled “Reconfigurable Overhead Aisle Sign” discloses a relatively recent attempt to introduce innovation to Aisle Markers.

### SUMMARY

There is described an aisle marker for a retail store which includes a body and a mounting apparatus for mounting the body. At least one electronic display is mounted on the body. A processing unit is provided controlling content displayed on the at least one electronic display. At least one security camera is supported by the body. A power linkage extends through the mounting apparatus for providing power. A two way communications link provides instructions to the processing unit and sends data.

The electronic displays can be used for multiple purposes. The electronic displays satisfy the traditional purpose of aisle marker wherein items located in that aisle are displayed on the aisle marker. Further, the electronic displays provide the flexibility to play a video advertisement or any screen play programmed into the processing unit, while having the items indicated to be down that aisle displayed around the video display unit. Each video display device is connected to a content processing unit that has the ability to be remotely updated. To provide network connectivity to all subcomponents of this device, a network switch device is incorporated providing Ethernet connections to every subcomponent.

The aisle marker contains one or more CCTV camera modules. The CCTV camera modules provide a previously unrealized view point for a security network to further facilitate loss prevention within the establishment. They also can be used to identify slip and fall hazards in the aisles due to spillage and have them quickly addressed. These cameras can be further leveraged for customer counting and data gathering for further analysis and analytics. The incorporation of the CCTV camera modules into the aisle marker can also address security needs in other manners, such as through facial recognition. Front and rear facing CCTV modules or a single 360 degree CCTV module mounted on the bottom side provide the video capture component of the device.

The aisle marking device is mounted via a mounting apparatus. The mounting apparatus provides a conduit for the requisite power and network cables to inconspicuously connect the aisle marking device to power and network respectively. The power is provided via an electrical outlet and one or more power converters are provided to supply one or more power profiles required by the (5 Volt (V), 12V, 24V, 48V, 120V, 240V) required by the different subcomponents of this device.

Optionally, the aisle marker may contain a WiFi access point within it which allows for the establishment or expansion of WiFi network coverage. A WiFi access point module allows for the establishment of a new, or expansion of an existing WiFi network. The WiFi access point module is mounted within the aisle marking device in a concealed manner and connects to the network switch device. A WiFi MAC address capturing module is included in the rear and front facing content processing units.

Optionally, the aisle marker may also contains optional public announcement (PA) speaker(s). The PA speaker(s) allow the transmission of audio signals from an audio generating device. Such a use could be for making announcements, playing music, or any use of audio signal transmission. The advantage this combination device provides is the installation of PA speaker(s) among other components without the need for additional wires.

### BRIEF DESCRIPTION OF THE DRAWINGS

FIG. 1 is an exploded view of the aisle marking device showing the general configuration of all the subcomponents of the device.

FIG. 2 is a view of the front facing side of the aisle marking device.

FIG. 3 is a view of the rear facing side of the aisle marking device.

FIG. 4 is a view of the front facing side of the aisle marking device depicting an alternate configuration utilizing a single bottom mounted 360 view degree camera module.

FIG. 5 is a view of the rear facing side of the aisle marking device depicting an alternate configuration utilizing a single bottom mounted 360 degree view camera module.

FIG. 6 is a view showing the left side of the aisle marking device showing the side panel, front and rear facing outer shell as well as the mounting apparatus.

FIG. 7 is a view showing the right side of the aisle marking device showing the side panel, front and rear facing outer shell as well as the mounting apparatus.

FIG. 8 is a view showing the left side of the aisle marking device in an alternate configuration utilizing a single bottom mounted 360 degree view camera module.

FIG. 9 is a view showing the right side of the aisle marking device in an alternate configuration utilizing a single bottom mounted 360 degree view camera module.

FIG. 10 is a view of the bottom side of the aisle marking device showing the configuration of the device without a PA speaker(s) nor a single bottom mounted 360 degree view camera module.

FIG. 11 shows a bottom view of the aisle marking device in the configuration including PA speaker(s).

FIG. 12 shows a bottom view of the aisle marking device in the configuration including PA speaker(s) and a single bottom mounted 360 degree view camera module.

FIG. 13 shows a bottom view of the aisle marking device in the configuration with a single bottom mounted 360 degree view camera module.

FIG. 14 shows a top view of the aisle marking device showing the mounting apparatus, the front and rear facing outer shells, and the front and rear cooling fans.

### DETAILED DESCRIPTION

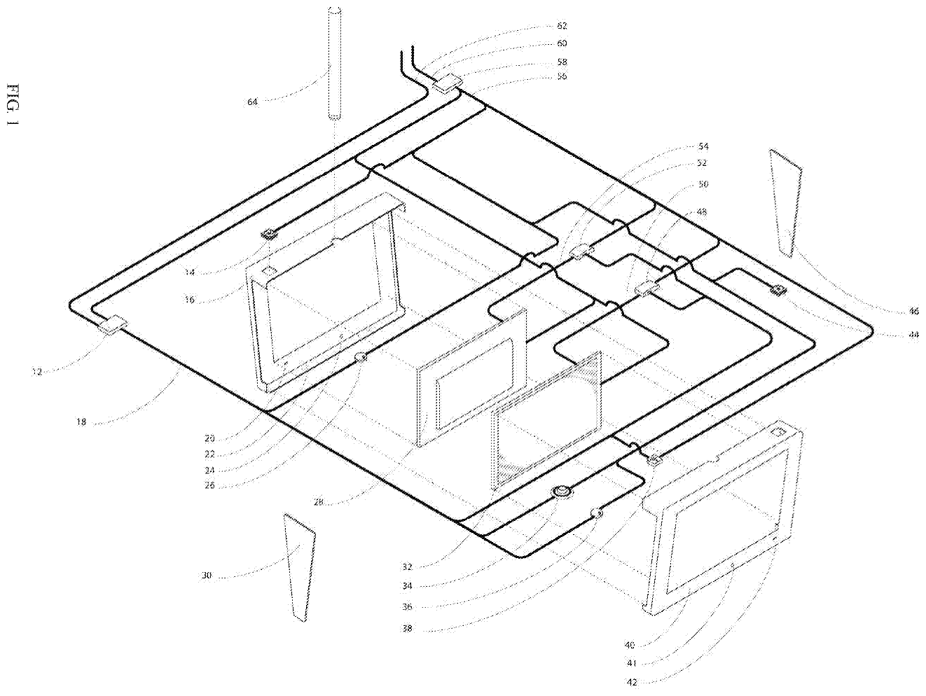

There will now be described an aisle marker for a retail store with reference to FIG. 1 through FIG. 14.

Referring to FIG. 1, mounting apparatus 64 shows that the mounting apparatus extends from a mount point and attaches to rear facing outer shell 16 and front facing outer shell 40. Power cable 60 and Ethernet cable 62 travel from their respective sources and into the aisle marking device to connect with its subcomponents. Rear facing outer shell 16 and front facing outer shell 40, fit together onto mounting apparatus 64. Left and right side panels 30 and 46 respectively complete the outer housing of the aisle marking device. Power module 58 receives power through power cable 60 and then converts to the power to the various voltages required to power the subcomponents of the aisle marking device. Subcomponents 12, 14, 26, 28, 32, 34, 36, 38, 44, 48, and 52 all connect to power module 58 to receive their respective power requirements. As indicated in FIG. 1, rear video display device 28 is connected to rear outer shell 16 and front video display device 32 is connected to front outer shell 40. Rear facing camera module 26 is connected to rear outer shell 16 at camera module hole 24. Similarly, front facing camera module is connected to front facing outer shell 40 at front facing camera module hole 41. Optional PA speaker(s) 34 are connected to rear and front facing outer shells 16 and 40 so that the generated audio is able to escape the aisle marking device through speaker holes 22. WiFi access point 38 allows the aisle marking device to either establish a WiFi network or act as an expansion on an already existing WiFi network. Rear and front facing cooling fans 14 and 44 respectively are used to circulate the air within the aisle marking device to ensure operational temperatures are maintained. Rear and front facing content processing units 52 and 48 respectively connect to their associated video display devices via video signal cables 54 and 50 respectively. The content processing units allow for the control and display of videos on the video display devices, while at the same time monitoring local radio MAC addresses. Network module 12 connects to subcomponents 26, 34, 36, 38, 48, and 52 of the aisle marking device. Network module 12 receives Ethernet connection via Ethernet cable 62. Rear and front IR sensor holes 20 and 42 respectively are in place so that remote IR signals can be utilized to manually control the video display devices within the aisle marking device.

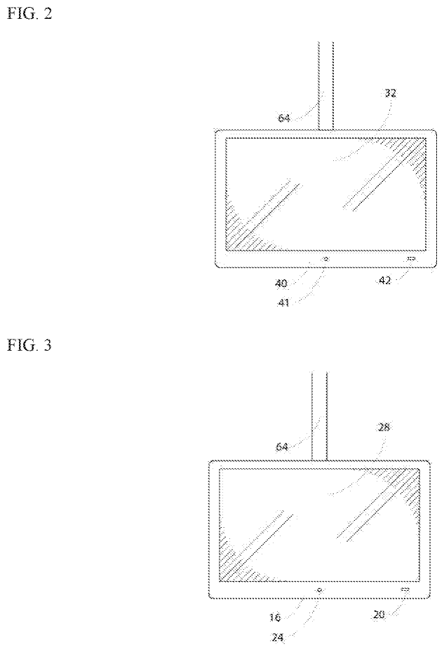

Referring to FIG. 2, the mounting apparatus 64 attaches to front facing outer shell 40 which houses the front facing video display device 32. The front facing outer shell 40 has camera module hole 41 and IR sensor hole 42 in it.

Referring to FIG. 3, the mounting apparatus 64 attaches to rear facing outer shell 16 which houses the rear facing video display device 28. The rear facing outer shell 16 has camera module hole 24 and IR sensor hole 20 in it.

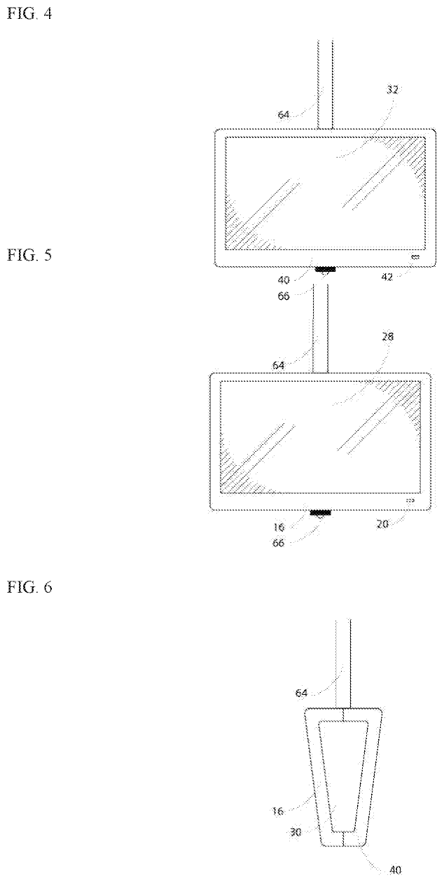

Referring to FIG. 4, an alternate configuration of the aisle marking device is depicted. Mounting apparatus 64 attaches to front facing outer shell 40. Front facing outer shell 40 houses the front facing video display device 32. Front facing outer shell 40 has the IR sensor hole 42 though it lacks camera module hole 41. In this configuration, a single 360 degree view camera module 66 is mounted to the bottom of the aisle marking device, connected to the bottom of rear and front facing outer shells 16, and 40.

Referring to FIG. 5, an alternate configuration of the aisle marking device can be seen. The mounting apparatus 64 connects to the rear facing outer shell 16. Rear video display device 28 is housed in rear outer shell 16. Rear outer shell 16 has only the IR sensor hole 20 and is lacking the rear facing camera module hole 24 that is found in other configurations. Rather than a rear facing camera module hole 24 and the mirrored counter part 41 as seen in FIG. 1, a single bottom mounted 360 degree view camera module 66 is used.

Referring to FIG. 6, a left side view of the aisle marking device is shown. The mounting apparatus 64 attaches to rear and front outer shells 16 and 40. Left side panel 30 attaches to rear and front outer shells 16 and 40, completing the outer housing's left side of the aisle marking device.

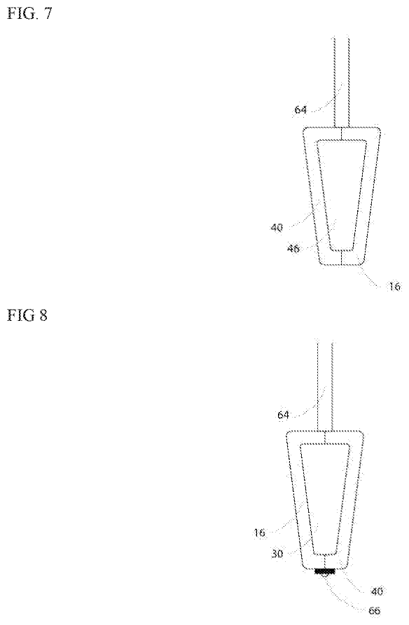

Referring to FIG. 7, a right side view of the aisle marking device is shown. The mounting apparatus 64 attaches to rear and front outer shells 16 and 40. Right side panel 46 attaches to rear and front outer shells 16 and 40, completing the outer housing's right side of the aisle marking device.

Referring to FIG. 8, an alternative configuration of the aisle marking device's left side can be seen. The mounting apparatus connects to the rear and front outer shells 16 and 40. Left side panel 30 attaches to the rear and front facing outer shells 16 and 40 to complete the outer housing's left side. In this configuration a single 360 degree view camera module 66 is mounted to the bottom of the rear and front outer shells 16 and 40.

Referring to FIG. 9, an alternate configuration of the aisle marking device's right side can be seen. The mounting apparatus connects to the rear and front outer shells 16 and 40. Right side panel 46 attaches to the rear and front facing outer shells 16 and 40 to complete the outer housing's right side. In this configuration a single 360 degree view camera module 66 is mounted to the bottom of the rear and front outer shells 16 and 40.

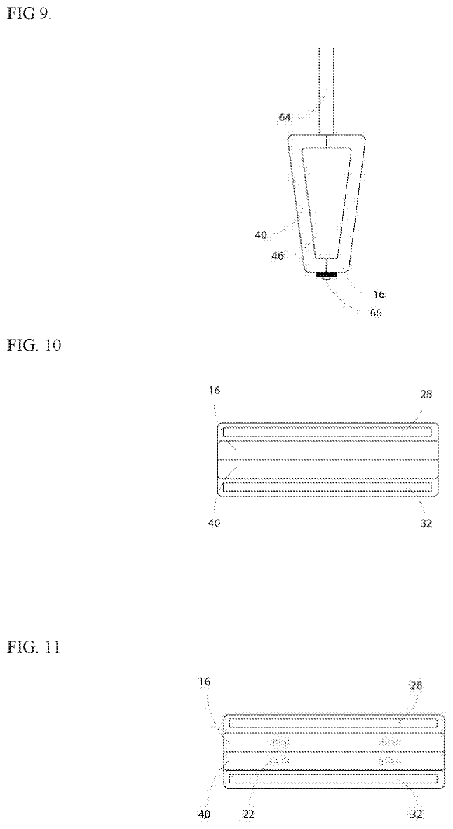

Referring to FIG. 10, the bottom view of the aisle marking device can be seen. In this configuration, there are no speaker holes 22 present, nor a single 360 degree view camera module 66. Therefore there are rear and front facing camera module holes, 24 and 41 respectively, in the rear and front facing outer shells 16 and 40 as seen in FIG. 2 and FIG. 3. Rear and front video display devices 28 and 32 are shown in rear and front facing outer shells 16 and 40.

Referring to FIG. 11, speaker holes 22 can be seen on the bottom of rear and front facing outer shells 16 and 40. Rear and front facing video display devices 28 and 32 can also be seen from this bottom view. In this configuration, the single bottom mounted 360 degree view camera module 66 is missing. This then indicated that rear and front facing camera module holes 24 and 41 are present in rear and front facing outer shells 16 and 40 as seen in FIG. 2 and FIG. 3. Rear and front video display devices 28 and 32 are shown in rear and front facing outer shells 16 and 40.

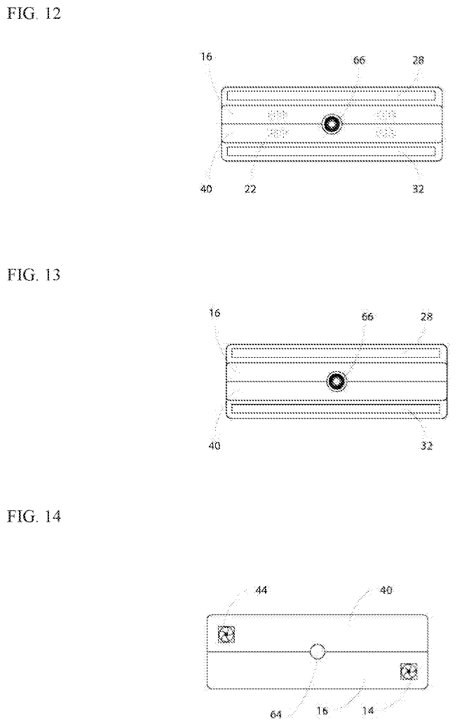

Referring to FIG. 12, a view of the bottom of the aisle marking device can be seen. Speaker holes 22 and a single bottom mounted 360 degree view camera module 66 can both be seen on the bottom of rear and front facing outer shells 16 and 40 respectively. The rear and front facing video display devices 28 and 32 can be seen in the bottom view.

Referring to FIG. 13, a bottom view of the aisle marking device can be seen in an alternate configuration with no speaker holes present and a single 360 degree view camera module 66 mounted to the bottom of rear and front facing outer shells 16 and 40 respectively. Rear and front facing video display devices 28 and 32 can be seen in the bottom view. This is due to the angle of the outer shells as depicted in FIG. 6, FIG. 7, FIG. 8, and FIG. 9. Since the rear and front facing outer shells 16 and 40 are angled, from a bottom view the video display devices would be partially visible when looking directly up at the aisle marking device.

Referring to FIG. 14, a top view of the aisle marking device can be seen. Rear and front cooling fans 14 and 44 can be seen mounted in the top of rear and front facing outer shells 16 and 40 respectively. These fans provide air circulation within the aisle marking device, to keep the internal subcomponents cool enough to function without overheating. The mounting apparatus 64 is shown to be connected to rear and front facing outer shells 16 and 40.

What is claimed is:

1. An aisle marker for a retail store, comprising:
a body;
a mounting apparatus from which the body is suspended;
at least one electronic display mounted on the body;
at least one processing unit controlling content displayed on the at least one electronic display;
at least one security camera supported by the body;
a power linkage extending through the mounting apparatus for providing power;
a two way communications link for providing instructions to the at least one processing unit and for sending data.

2. An aisle marker for a retail store, comprising:
a body having a front and a rear;
a mounting apparatus from which the body is suspended, the mounting having a cable port;
a front facing electronic display mounted on the front of the body;
a rear facing electronic display mounted on the rear of the body;
a processing unit controlling content displayed on the front facing electronic display and the rear facing electronic display;
a front facing security camera supported by the body;
a rear facing security camera supported by the body;
a power linkage extending through the cable port of the mounting apparatus for providing power to the front facing electronic display, the rear facing electronic display, the processing unit, the front facing security camera and the rear facing security camera; and
a two way communications link for providing instructions to the processing unit and for sending data from the front facing security camera and the rear facing security camera.

3. The aisle marker for a retail store of claim 2, wherein the communications link is WiFi.

4. The aisle marker for a retail store of claim 3, including a WiFi MAC address capturing module.

5. The aisle marker for a retail store of claim 2, wherein at least one audio speaker is mounted to the body.

6. The aisle marker for a retail store of claim 2, wherein the front facing security camera and the rear facing security camera are concealed within the body.
